(19) United States
(12) Patent Application Publication
(10) Pub. No.: US 2004/0178661 A1
(43) Pub. Date: Sep. 16, 2004

(54) Apparatus for attaching a part to a surface of a vehicle body

(76) Inventors: Larry Andrew Filipczak, West Bloomfield, MI (US); Harry L. Renshaw III, Sterling Hts., MI (US); William A. Hancock, Huntington Woods, MI (US)

Correspondence Address: LAURA C. HARGITT, General Motors Corporation, Legal Staff, Mail Code 482-C23-B21, P.O. Box 300, Detroit, MI, 48265-3000, US

(21) Appl. No.: 10/364,205

(22) Filed: Feb. 11, 2003

(51) Int. Cl. B60J 10/00

(52) U.S. Cl. 296/181.1; 296/1.01

(57) ABSTRACT

The present invention concerns an apparatus for attaching a part, such as a trim component, to a surface of a vehicle body. The apparatus includes an elongated flange adapted to be attached to and extend outwardly from the body surface. The flange includes a head portion connected to a body portion and the head portion has a greater width than the body portion. The apparatus also includes an elongated carrier adapted to be attached to a part. The carrier has a body with a generally C-shaped profile extending between opposed edges, and a flexible projection extending from each edge of the carrier body, the projections extending toward one another to define an opening therebetween. The opening has a width less than the width of the flange head. When the flange body portion is attached to the surface of the vehicle body and the carrier opening is aligned with the flange head portion, a force is then applied to the carrier and the projections deflect, permitting the flange head portion to pass therebetween. The projections then spring back toward the flange body portion to retain the carrier on the flange.

### BACKGROUND OF THE INVENTION

The present invention relates generally to seals and trim components attached to a vehicle body and, in particular, to an apparatus for attaching a part, such as a seal or a trim component, to a surface of a vehicle body.

Prior art seals that are necessary in restricted environments in automotive vehicles are typically held in place with spray adhesives or adhesive tapes. Alternatively, the seal is held in place by a small flange mounted carrier with pumpable adhesive inside the carrier, or the seal is mounted onto a T-shaped flange. The spray adhesives, the adhesive tapes, and the pumpable adhesives, however, are expensive options to incorporate into the design of the seal. In addition, the T-shaped flange is very difficult to install by assemblers.

Prior art means for securing trim components on vehicle surfaces include the use of screws, rivets, retainer clips, or double-sided adhesive tapes to secure the trim components, such as door appliqué moldings and the like, to the surface of the vehicle body, such as a door header. Other door appliqués and the like are retained to the vehicle body by clips that are molded into the plastic appliqué. These clips mate with corresponding holes or slots that are punched into the vehicle body surface. The size and location of these slots disadvantageously require some amount of maintenance by both the sheet metal vendors and the assembly plant. The fasteners also disadvantageously add to the cost of the trim component.

It is desirable, therefore, to provide a means for attaching a part to a vehicle body surface that is easy to assemble and manipulate. It is also desirable to provide a cost-effective means for attaching a seal or a part to a vehicle body surface without the use of adhesives or fasteners to ensure retention.

### SUMMARY OF THE INVENTION

The present invention concerns an apparatus for attaching a part, such as a trim component, to a surface of a vehicle body. The apparatus includes an elongated flange adapted to be attached to and extend outwardly from a surface of a vehicle body. The flange includes a head portion connected to a body portion and the head portion has a greater width than the body portion. The apparatus also includes an elongated carrier adapted to be attached to a part. The carrier has a body with a generally C-shaped profile extending between opposed edges, and a flexible projection extending from each edge of the carrier body that defines an opening therebetween. The opening has a width less than the width of said flange head. When the flange body portion is attached to the surface of the vehicle body, the carrier opening can be aligned with the flange head portion. A force is then applied to the carrier and the projections deflect, permitting the flange head portion to pass therebetween. The projections then spring back toward the flange body portion to retain the carrier on the flange.

The design of the present invention is based on the carrier, which is C-shaped and may be advantageously utilized for a seal or a trim component. The projections extending from each edge of the carrier body retain the carrier to the flange by column loading the extraction forces and transferring the energy over the length of the part. This load increases the engagement of the seal or the trim component, preventing its removal.

The head portion and the body portion of the mounting flange is preferably diamond-shaped to allow easy insertion into the carrier portion, which reduces the installation efforts by the assembler in the assembly plant. The amount of installation effort can be varied by varying the length of the projections that are inserted into the carrier portion or by varying the width of the carrier section and thus the opening of the carrier section. Preferably, the carrier portion produces an audible “snap” when it is engaged properly. This is an auditory cue for the assembler that the part is fully installed.

The shape or profile of the part, the carrier, and the flange, however, are variable and are dependent on the criteria of the materials and construction methods used for the product design. The apparatus according to the present invention can be utilized with various types of materials including, but not limited to, aluminum, plastic, rubber, molded plastic or extruded plastic.

The apparatus according to the present invention can be advantageously utilized for components or parts such as seals, weatherstrip carriers, and trim components and allows for maximum part retention in a confined environment without the use of adhesive tape, pumpable adhesives inside of the carrier section, or additional fasteners to retain the part to the surface of the vehicle body. The use of the present invention results in a reduction in the cost of the part and a reduction in assembly plant labor required to install the parts.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a fragmentary end view of an apparatus for attaching a part to a surface of a vehicle body in accordance with the present invention, shown in an unengaged position;

FIG. 2 is a fragmentary end view of the apparatus in FIG. 1, shown in an engaged position; and

FIG. 3 is a perspective view of a portion of the vehicle body shown with a flange of the apparatus of FIG. 1 attached thereto.

### DESCRIPTION OF THE PREFERRED EMBODIMENT

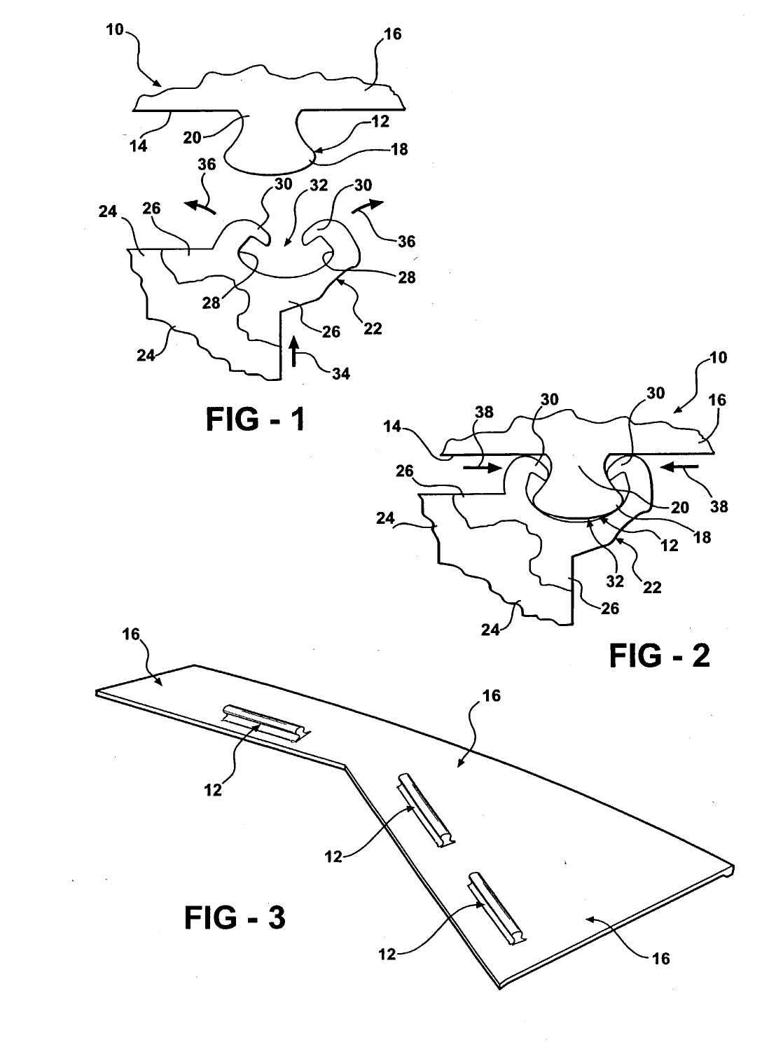

Referring now to FIG. 1, an apparatus for attaching a part to a surface of a vehicle body in accordance with the present invention is indicated generally at 10, and is shown in an unengaged position. The apparatus 10 includes an elongated flange 12 that is adapted to be attached to and extends outwardly from a surface 14, such as a door panel, a vehicle rocker molding, a sunroof, a door appliqué, or the like, of a vehicle body 16. The flange 12 includes a head portion 18 connected to an outer end of a body portion 20 having an inner end connected to the body 16. The head portion 18 has a greater width than the body portion 20.

The apparatus 10 also includes an elongated carrier 22 adapted to be attached to a part 24, such as a trim part, a seal, or the like. The carrier 22 has a body 26 with a generally C-shaped profile extending between opposed edges 28, and a flexible projection 30 extending from each edge 28 of the carrier body 26 toward one another which projections 30 define an opening 32 therebetween. The opening 32 has a width less than the width of the flange head portion 18.

Referring now to FIGS. 1, and 2, when the flange body portion 20 is attached to the surface 14 of the vehicle body 16, the carrier opening 32 is then aligned with the flange head portion 18. A force, in an engaging direction indicated by an arrow 34, is then applied to the carrier 22 and the projections 30 deflect in a deflecting direction indicated by an arrow 36, permitting the flange head portion 18 to pass between each of the projections 30. Because the flange head portion 18 has a width greater than the flange body portion 20, the force in the engaging direction 34 is much less than the force required in the prior art.

After the flange head portion 18 passes between the projections 30, the projections 30 then spring back in a returning direction indicated by an arrow 38 toward the flange body portion 20 to retain the carrier 22 on the flange 12, best seen in FIG. 2. The projections 30 of the carrier 22 produce an audible “snap” when the projections 30 spring back towards the flange body portion 20, providing an auditory cue that the carrier 22 is engaged properly with the flange 12. Once assembled, the outer surfaces of the projections 30 are in contact with the body portion 20 of the flange 12. The projections 30 retain the carrier 22 to the flange 12 by column loading the extraction forces and transferring the energy over the length of the apparatus 10. Column loading the extraction forces increases the engagement of the carrier 22 with the flange 12, advantageously preventing the removal of the carrier 22 and thus the part 24 from the flange 12 and the vehicle body 16.

Referring now to FIG. 3, a portion of the vehicle body 16 is shown in perspective having a plurality of elongated flanges 12 attached to a surface thereof. The flanges 12 and the portion of the vehicle body 16 are adapted to be attached to corresponding one or more elongated carriers (not shown), such as the carrier 22 of FIGS. 1 and 2, extending from a surface of a part (not shown), such as the part 24 of FIGS. 1 and 2.

In accordance with the provisions of the patent statutes, the present invention has been described in what is considered to represent its preferred embodiment. However, it should be noted that the invention can be practiced otherwise than as specifically illustrated and described without departing from its spirit or scope.

1. An apparatus for attaching a part to a surface of a vehicle body, comprising:
an elongated flange adapted to be attached to and extend outwardly from a surface of a vehicle body, said flange having a head portion connected to a body portion, said head portion having a greater width than said body portion; and
an elongated carrier adapted to be attached to a part, said carrier having a body with a generally C-shaped profile extending between opposed edges, and a flexible projection extending from each said edge of said carrier body, said projections extending toward one another defining an opening therebetween having a width less than said width of said flange head,
whereby when said flange body portion is attached to the surface of the vehicle body, said carrier opening is aligned with said flange head portion and a force is applied to said carrier, said projections deflect permitting said flange head portion to pass therebetween and then spring back toward said flange body portion to retain said carrier on said flange.

2. The apparatus according to claim 1 wherein said flange is generally mushroom-shaped.

3. The apparatus according to claim 1 wherein said flange and said carrier are formed from an aluminum, plastic, rubber, molded plastic or extruded plastic material.

4. An assembly for attaching a part to a surface of a vehicle body, comprising:
an elongated part having an outer surface;
at least one elongated flange adapted to be attached to and extend outwardly from a surface of a vehicle body, said at least one flange having a head portion connected to a body portion, said head portion having a greater width than said body portion; and
at least one elongated carrier adapted to be attached to said outer surface of said part, said at least one carrier having a body with a generally C-shaped profile extending between opposed edges, and a flexible projection extending from each said edge of said carrier body, said projections extending toward one another defining an opening therebetween having a width less than said width of said flange head,
whereby when said flange body portion is attached to the surface of the vehicle body, said carrier opening is aligned with said flange head portion and a force is applied to said carrier, said projections deflect permitting said flange head portion to pass therebetween and then spring back toward said flange body portion to retain said at least one carrier and said part on said at least one flange.

5. The apparatus according to claim 4 wherein said part is an automotive trim component.

6. The apparatus according to claim 5 wherein said trim component is a door applique.

7. The apparatus according to claim 4 wherein said part is an automotive seal.

8. The apparatus according to claim 7 wherein said seal is a weatherstripping.

9. The apparatus according to claim 4 wherein said at least one flange and said at least one carrier are formed from an aluminum, plastic, rubber, molded plastic or extruded plastic material.
